(19) United States
(12) Patent Application Publication
(10) Pub. No.: US 2006/0256726 A1
(43) Pub. Date: Nov. 16, 2006

(54) Systems and methods for viewing data in a trace buffer

(76) Inventor: Lynn M. Jennings, Rochester, NY (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/256,799

(22) Filed: Oct. 24, 2005

Related U.S. Application Data
(60) Provisional application No. 60/679,307, filed on May 10, 2005.

(51) Int. Cl. H04L 12/26

(52) U.S. Cl. 370/241

(57) ABSTRACT

Systems and methods for analyzing a trace of network data. A protocol analyzer captures network data in a trace buffer when a trigger event is detected. The trace of network data in the trace buffer can then be searched for specific events. A hardware search of the trace may be performed to locate the specific events. The analysis of the trace is focused at the specific events located by the search of the trace. An index is used to identify which portions of the trace have been analyzed. The trace can then be saved along with the index without completing the analysis of the trace. When the analysis is completed, those portions of the trace that are already analyzed can be skipped.

### CROSS-REFERENCE TO RELATED APPLICATIONS

This application claims the benefit of U.S. Provisional Application No. 60/679,307 filed May 10, 2005 and entitled “Systems and Methods for Viewing Data in a Trace Buffer,” which is incorporated by reference in its entirety.

### BACKGROUND OF THE INVENTION

1. The Field of the Invention

Embodiments of the invention relate to systems and methods for analyzing network data captured in a trace. More particularly, embodiments of the invention relate to systems and methods for viewing data in a trace buffer.

2. The Relevant Technology

In order for a communication system such as a network to be effective and operate at peak performance, it is often necessary to have an understanding of what is happening in the network. One type of instrument used to achieve this goal and to understand what is happening in a network is a protocol analyzer or monitor. Protocol analyzers can provide a detailed view of what is happening in a network environment (e.g., SAN, LAN, WAN) moment by moment.

There is often a desire to quickly resolve complex problems in network communications. While protocol analyzers enable a rapid resolution of complex problems, protocol analyzers can also identify certain problems and the conditions that lead to those problems before those problems become critical and negatively impact the performance of the network. The resolution of events or situations in a network that cause problems can enable users to more effectively design, implement, and evaluate their networks and their network components.

One approach to problem identification, analysis, and resolution in communications systems involves capturing a portion of the network data traffic for review and analysis. In some cases, such data capture is performed in connection with an analyzer that includes various hardware and software elements configured to capture data from one or more communications links in the communications system, and to present the captured data in various formats to a user or technician by way of a graphical user interface or other device. The captured data is often referred to as a trace and one of skill in the art can recognize that a trace can be very large. Analyzers are beginning, for example, to capture hundreds of Gigabytes and will soon be capturing Terabytes of data.

The analysis of hundreds of Gigabytes or Terabytes is not a quick process. A protocol analyzer performs thousands of operations on the data in a trace. The complexity of the analysis performed by a protocol analyzer has a corresponding cost in terms of both computing resources and time. In addition to computer resources, a typical trace, for example, may take a substantial amount of time to analyze. This time is incurred even when the user has an idea of what the error represents.

### BRIEF SUMMARY OF THE INVENTION

These and other limitations are overcome by embodiments of the invention, which relate to systems and methods for analyzing a trace of network data. A protocol analyzer has the ability to detect events including, but not limited to, bit patterns, protocol data, and the like. Some of these events can be defined as trigger events. When a trigger event is detected, the network data is captured into a trace buffer. The trace of network data can then be analyzed.

Instead of analyzing the entire trace, which can consume substantial time, the search can locate events that a user expects to occur in the trace. The analysis can be focused on the data that is at or near these events. After analyzing a portion of the data, the search can be performed again to identify another instance of a certain event or to find another type of event in the trace. Again the analysis can be focused at or near the located events.

An index is used to track or identify those portions of the trace that have been analyzed. Advantageously, the entire trace does not need to be analyzed. In one embodiment, the trace and the index can be saved together. In other words, the analysis of the trace does not need to be completed. When the trace and index are retrieved at a later time, the analysis can then be completed. The index can be used to skip those portions of the trace that have already been analyzed.

One embodiment of the invention includes a method for focused analysis of a trace generated by a protocol analyzer. A trace of network data is collected based on a detected trigger event and the trace is then searched for an event identified or specified by a user. Often, the specified event is one the user expects to find in the trace. After an instance of the specified event is found, an analysis of the data at or near the specified event is performed. The search can then be repeated if necessary to identify other instances of the specified event or for another event in the trace. An index may be used to represent those portions of the trace that have been analyzed. The trace can be saved along with the index, or the analysis of the entire trace can be completed beginning at any point of the trace. Portions of the trace that have already been analyzed are typically skipped.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment including a protocol analyzer for implementing embodiments of the invention;

FIG. 2 illustrates one embodiment of a trace captured by a protocol analyzer and the events identified by a search of the trace;

FIG. 3 illustrates one embodiment of an index that identifies at least which portions of a trace have been analyzed; and

FIG. 4 illustrates an exemplary method for focused viewing of a trace captured by a protocol analyzer.

### DETAILED DESCRIPTION OF THE PREFERRED EMBODIMENTS

Protocol analyzers and other devices can resolve events that can degrade the performance of a network such as, by way of example, a local area network (LAN), a wide area network (WAN), or a storage area network (SAN). A protocol analyzer tests or evaluates a network by automatically capturing data and then analyzing the captured data. A protocol analyzer is often embodied as a combination of hardware and software.

The hardware, for example, of a protocol analyzer may include a tap that can be placed in-line with the network communications. A tap can also be non-intrusive. When an event occurs or is detected, the protocol analyzer triggers and captures data into a trace. The software provides processing functionality to sort through the trace and identify information related to the event that triggered the data capture. The analysis performed by a protocol analyzer is complex and can consume substantial time.

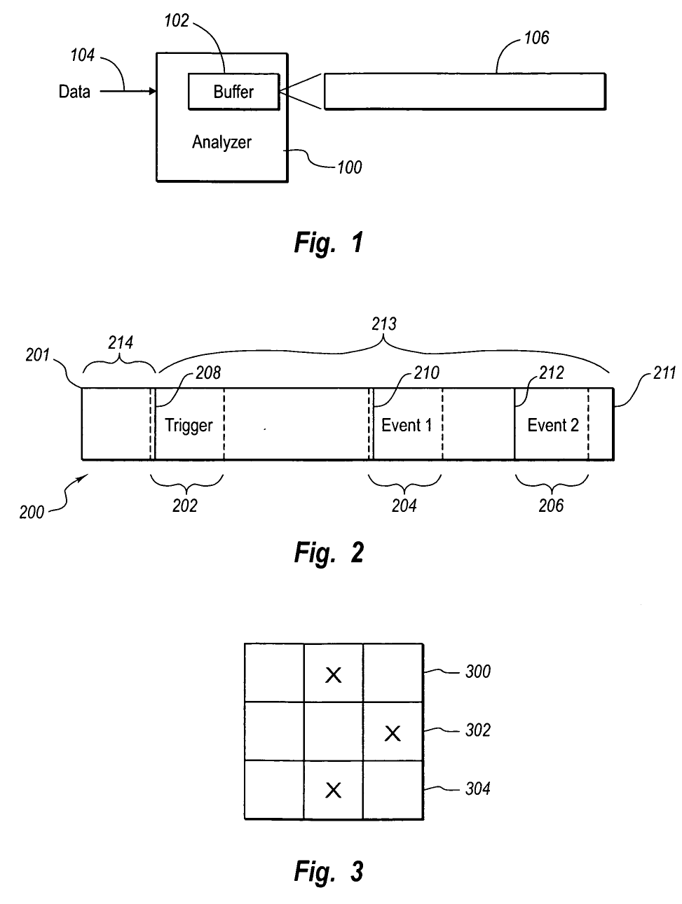

FIG. 1 illustrates an example of a protocol analyzer used to analyze network data. The analyzer 100 is connected to a network connection 104 that carries data including network data. The analyzer 100 is typically programmed to monitor the data for certain events. The events that the analyzer 100 is looking for can be identified by a user or set automatically. The analyzer 100 may also look for events that have not been identified by a user. When one of these events is detected, the analyzer 100 triggers and stores the network data in a trace buffer 102.

The trace buffer 102 therefore contains the network data 106 that was present on the network connection 104 when some event was detected by the analyzer 100. The implementation of the trace buffer 102 can vary such that the bounds of the data 106 can vary. In one embodiment, the trace buffer 102 is a circular buffer. In other words, the trace buffer 102 is continuously collecting new data that overwrites some of the old data. Advantageously, this can ensure that some of the data that was present prior to the triggering event is still captured in the trace buffer 102.

Thus, the bounds of the data 106 in the trace buffer 102 can vary and be determined by the type of trigger or set by user preferences. Generally, the data 106 can correspond only to (i) data on the network connection 104 that occurred after the detected event, (ii) data on the network connection 104 that occurred just prior to the detected event, or (iii) a combination of (i) and (ii). Often, the data in the trace buffer 102 occurred after the detected event and a small portion of the data in the trace buffer 102 occurred prior to the detected event.

After the data 106 is captured, it is ready for protocol analysis. Conventionally, all of the data 106 in the trace is analyzed before results are provided to a user. Therefore, a user is required to wait until the analysis is finished before evaluating the results of the analysis. As previously indicated, an analysis of the trace requires processing a very large number of events in order to identify, by way of example, performance issues, upper layer protocol issues, logical and physical layer issues, and the like.

Embodiments of the invention enable the analysis to be focused to a specific part of the trace and surrounding data. Focusing the analysis can be combined with trace indexing to identify which portions of the trace have been analyzed. This ensures that the portions of the trace that are already analyzed can be skipped when the trace is fully analyzed.

FIG. 2 illustrates an exemplary trace that can be analyzed in accordance with embodiments of the present invention. The trace 200 in FIG. 2 was captured by a protocol analyzer 100 upon the detection of the trigger event 208. This example of the trace 200 includes data 213 that occurred after the trigger event 208 and the data 214 that occurred just prior to detection of the trigger event 208.

In a conventional analysis of the trace 200, the analysis typically begins at the beginning 201 of the trace and proceeds to the end 211 of the trace 200. A conventional analysis of the trace 200 can consume substantial time. Embodiments of the invention relate to a focused viewing or to a focused analysis of the trace 200.

In one example, a user often has an idea of certain events (which may differ from or be related to the trigger event 208) that should be included in the trace 200. Embodiments of the invention enable a user to search for those events and begin the protocol analysis at locations in the trace 200 where the events are located. Searching the trace 200 for a particular event is typically much faster (on the order of less than a second) than performing a full analysis of the trace 200 (which can take tens of minutes).

In one example, a hardware search is performed on the trace 200 to find a data pattern corresponding to an event identified by a user. Examples of a hardware search are found and described in U.S. Pat. No. 6,266,278 (B1) and U.S. Pat. No. 6,393,587, which are hereby incorporated by reference in their entirety.

A user may identify or initiate a search through the trace 200 for the event 210 or for the event 212. In one embodiment, a hardware search of the trace 200 is performed to identify the event 210 or the event 212. The protocol analysis of the trace 200 begins at or near the events located by the hardware search or software search of the trace 200.

Once an event such as the event 210 is located, the protocol analysis is performed for the data 204, which begins in this example a little bit before the event 210 in the trace 200. One of skill in the art can appreciate that the beginning data boundary of the analysis focused by the event 210 can begin prior to, coincident with, or after the event 210. For example, the starting point of the analysis of the data 206 associated with the event 212 coincides with the event 212. FIG. 2 further illustrates that the analysis can also begin at or near the point in the trace 200 that corresponds with the trigger event 208. In this case, the data 202 is analyzed beginning before the trigger event 208.

In each of the examples illustrated in FIG. 2, the analysis performed by the analyzer 100 is less than the entire trace. The data 202, the data 204, and the data 206 only represent non-contiguous portions of the trace 200. One advantage of focusing the analysis of the protocol analyzer 100 is that a problem can potentially be solved without having to analyze the entire trace 200. In other words, an analysis of the data 204, or of the data 206, etc., may be sufficient. This can save a user substantial time compared to waiting for and examining an analysis of the entire trace 200.

Embodiments of the invention also enable a partial analysis of the trace to be performed and remembered. FIG. 3, for example, represents an index 300 that is associated with the trace 200 in FIG. 2. One embodiment of the index 300 identifies portions 302 of the trace 200 that have been analyzed and portions 304 of the trace 200 that have not been analyzed.

For example, with reference to FIGS. 2 and 3, when the data 206 is analyzed the index 300 may be altered or set to reflect this fact. A user then has the ability to save the trace 200 without analyzing the rest of the trace 200. The trace 200 can then be retrieved at a later time or scheduled for a full analysis at a later time. Advantageously when the rest of the trace 200 is analyzed, the analysis of the data 206 or other portions of the trace that were previously analyzed is not performed a second time. The index 300 can guide the remaining analysis of the trace 200. The results of the analysis for the data 206 can be saved and then combined with the results of the rest of the analysis of the trace 200.

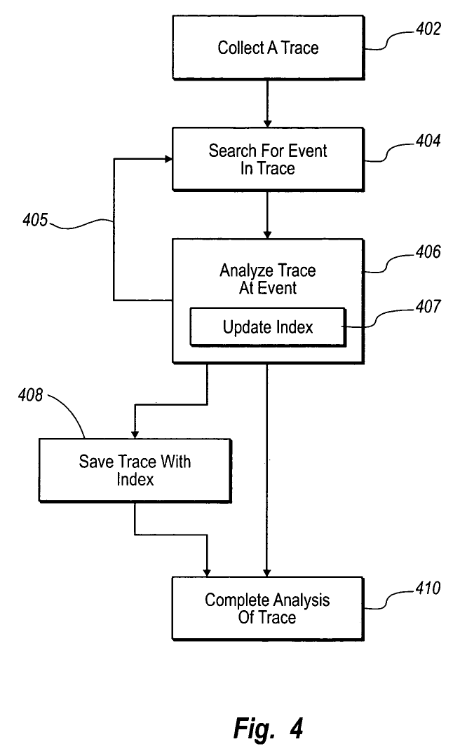

FIG. 4 illustrates an exemplary flowchart for focused viewing or focused analysis of a trace. Protocol analysis often begins with collecting a trace 402. Collecting a trace 402 is usually based on the detection of a trigger or a trigger event. For example, a user may either use default triggers provided by the analyzer 100 or a user may define certain bit patterns, protocol occurrences, and the like as triggers. When the trigger or trigger event is detected, a trace is collected by the analyzer. The size of the trace can be large. As previously stated, the size of the trace combined with the complex and detailed analysis performed by an analyzer 100 means that the analysis of a trace takes significant time. The trace may be collected in volatile and/or non-volatile memory.

After the trace is collected, a search is performed for an event 404 in the collected trace. As previously stated, the search can be a fast hardware search that can identify an event quickly. The event being searched for may be set by a user. For example, a user may have an idea of what to look for in the trace. With this information, a user can search the trace for these type of events. Bit patterns, protocol patterns, certain commands, etc. are examples of events that can be identified in a search of the trace.

A search for an event in the trace 404 can include a search for more than one event as well as a search for different events. The events can all be marked or identified, in one embodiment in the index. The index, in addition to identifying portions of the tract that have already been analyzed, can be used to mark locations of events in the trace. Examples of the search for an event can therefore be a search for all events in the trace or a search can be performed until a first instance of an event is found in the trace.

Next, an analysis of the trace is performed at the event 406. The analysis of the trace can begin before, at, or after the event found in the trace. In one embodiment, a complete analysis of the trace is performed beginning at the event found by the search 410. Alternatively, only a portion of the data around the event is analyzed. The amount or scope of the analysis can be set or determined by a user. In either case, the index is updated 407.

After the analysis of the data around the first event is completed, the method continues, as indicated by the arrow 405, back to the search. In one example, the index is used to identify the location of the next event in the trace and an analysis of the data in the trace is performed at that point and the index is updated accordingly. Alternatively, a search of the trace is continued to find the next instance of the event and an analysis is again performed at the next instance of the event. In each case, the index is updated to reflect at least the data in the trace that has been analyzed.

At any point during the analysis of the trace, the trace and the index can be saved 408. The index can identify which portions of the trace have been analyzed as well as other instances of events identified by the search of the trace. Later, the saved trace can be retrieved and the analysis of the trace can be completed 410. Those portions of the trace that have already been analyzed can be skipped.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for analyzing a trace captured by a protocol analyzer, the method comprising:
collecting a trace of network data;
searching for a particular event in the trace; and
analyzing the data in the trace at the particular event.

2. A method as defined in claim 1, wherein collecting a trace of network data further comprises detecting a trigger event.

3. A method as defined in claim 1, wherein searching for a particular event further comprises performing a hardware search for the particular event in the trace.

4. A method as defined in claim 1, wherein searching for a particular event in the trace further comprises performing a hardware search for a second event in the trace of the network data.

5. A method as defined in claim 1, further comprising creating an index, the index identifying portions of the trace that have been analyzed.

6. A method as defined in claim 5, wherein the portions of the trace that have been analyzed are not contiguous.

7. A method as defined in claim 5, further comprising saving the trace and the index.

8. A method as defined in claim 7, further comprising:
retrieving the saved trace and index; and
completing an analysis of the trace, wherein portions of the trace that are already analyzed are skipped.

9. A method for focused analysis of a trace generated by a protocol analyzer, the method comprising:
collecting a trace of network data based on a detected trigger event;
searching the trace for a particular event identified by a user;
performing an analysis of a portion of the data included in the trace of network data near the particular event; and
identifying the portion of the data as being analyzed in an index associated with the trace of network data.

10. A method as defined in claim 9, wherein collecting a trace of network data based on a detected trigger event further comprises capturing the network data in a trace buffer.

11. A method as defined in claim 9, wherein searching the trace for a particular event further comprises performing a hardware search of the trace for the particular event.

12. A method as defined in claim 9, wherein searching the trace for a particular event identified by a user further comprises performing a hardware search for a second event related to the trigger event.

13. A method as defined in claim 12, wherein the second even is identified by the user.

14. A method as defined in claim 9, wherein performing an analysis of a portion of the data included in the trace further comprises beginning the analysis of the portion of the data at one of:
before the particular event;
coincident with the particular event; and
after the particular event.

15. A method as defined in claim 9, further comprising performing a hardware search for another instance of the particular event in the trace.

16. A method as defined in claim 9, further comprising saving the trace and the index, wherein the index identifies which portions of the trace have been analyzed.

17. A method as defined in claim 16, wherein the portions of the trace that have been analyzed are not contiguous.

18. A method as defined in claim 9, further comprising completing an analysis of the trace using the index, wherein portions of the trace that have already been analyzed are skipped.

19. A method as defined in claim 9, further comprising updating the index after completing an analysis of the portion of the data near the particular event.

20. A protocol analyzer that focuses an analysis of a trace to specific portions of the trace, the protocol analyzer comprising:
a trace buffer that stores a trace of network data after a trigger event is detected;
a user interface through which a user identifies a particular event that is expected to occur in the trace of network data;
a hardware search engine that searches the trace for at least the particular event, wherein a first portion of the data in the trace near the particular event is analyzed; and
an index that represents at least which portions of the trace have been analyzed.

21. A protocol analyzer as defined in claim 20, wherein the index is a tree listing.

22. A protocol analyzer as defined in claim 20, wherein the hardware search engine further searches for a second event in the trace of network data, wherein a second portion of the data in the trace near the second event is analyzed and the index is updated.

23. A protocol analyzer as defined in claim 22, wherein the second portion of the data is not continuous with the first portion of the data.
